(19) United States
(12) Patent Application Publication
(10) Pub. No.: US 2024/0338360 A1
(43) Pub. Date: Oct. 10, 2024

(54) METHOD OF QUERYING INFORMATION, ELECTRONIC DEVICE, AND STORAGE MEDIUM

(71) Applicant: Beijing Baidu Netcom Science Technology Co., Ltd., Beijing (CN)

(72) Inventor: Jing QU, Beijing (CN)

(21) Appl. No.: 18/748,967

(22) Filed: Jun. 20, 2024

(30) Foreign Application Priority Data
Mar. 13, 2024 (CN) 202410288282.3

(51) Int. Cl. G06F 16/23; G06F 11/34; G06F 16/2453; G06F 16/25

(52) U.S. Cl. CPC G06F 16/2386; G06F 11/3409; G06F 16/2453; G06F 16/258

(57) ABSTRACT

A method of querying an information, an electronic device, and a storage medium are provided, which relate to a field of artificial intelligence technology, in particular to fields of large language model, information processing and intelligent office technologies. The method includes: acquiring a time period to be queried, a number of items to be queried and an object identification of a target object corresponding to the information query request, in response to receiving the information query request from the target object; processing the time period to be queried, the number of items to be queried, the object identification and a predetermined parameter format text to obtain a target parameter, where the target parameter represents an input parameter of a query interface of an information query system; and acquiring, by invoking the query interface, a target information from the information query system based on the target parameter.

### CROSS-REFERENCE TO RELATED APPLICATION(S)

This application claims the benefit of Chinese Patent Application No. 202410288282.3 filed on Mar. 13, 2024, the whole disclosure of which is incorporated herein by reference.

### TECHNICAL FIELD

The present disclosure relates to a field of artificial intelligence technology, in particular to fields of large language model, information processing and intelligent office technologies. Specifically, the present disclosure relates to a method of querying an information, an electronic device, and a storage medium.

### BACKGROUND

With in-depth applications of information technology, artificial intelligence technology and large language model-based natural language processing technology in various fields, digital office modes have been popularized in various aspects of daily management and operations of enterprises.

In a digital office mode, with a growth of business volume, a process of information query and processing is gradually complex, and an amount of information to be processed is also increasing. Therefore, there is an urgent need to provide a fast and efficient method of querying an information to reduce an impact of an information query on a processing speed of other processes.

### SUMMARY

The present disclosure provides a method of querying an information, an electronic device, and a storage medium.

According to an aspect of the present disclosure, a method of querying an information is provided, including: acquiring a time period to be queried corresponding to an information query request, a number of items to be queried corresponding to the information query request and an object identification of a target object corresponding to the information query request, in response to receiving the information query request from the target object; processing the time period to be queried, the number of items to be queried, the object identification and a predetermined parameter format text to obtain a target parameter, where the target parameter represents an input parameter of a query interface of an information query system; and acquiring, by invoking the query interface, a target information from the information query system based on the target parameter.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the method described above.

According to another aspect of the present disclosure, a non-transitory computer-readable storage medium having computer instructions therein, where the computer instructions are configured to cause a computer to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a method and an apparatus of querying an information may be applied according to embodiments of the present disclosure;

FIG. 2 schematically shows a flowchart of a method of querying an information according to embodiments of the present disclosure;

FIG. 3 schematically shows a schematic diagram of an information processing and storage process according to embodiments of the present disclosure;

FIG. 4 schematically shows a schematic diagram of a method of querying an information according to embodiments of the present disclosure;

FIG. 5 schematically shows a schematic diagram of a method of querying an information according to other embodiments of the present disclosure;

FIG. 6 schematically shows a block diagram of an apparatus of querying an information according to embodiments of the present disclosure; and

FIG. 7 schematically shows a block diagram of an electronic device suitable for implementing the method of querying the information according to embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In a digital office mode, current information queries are generally achieved based on a distributed message queue Kafka. However, when a network anomaly occurs to cause a congestion in a message queue or no messages to be consumed in the message queue, an information query service may be interrupted and a normal operation of a subsequent process may be affected.

In addition, the information query in relevant examples is based on a multi-proxy service in order to invoke an information query system. Anomaly in any proxy service may cause an interruption of the information query service.

In view of the above, embodiments of the present disclosure provide a method of querying an information, in which a time period to be queried, a number of items to be queried, and an object identification of a target object may be processed based on a predetermined parameter format text, so as to obtain a target parameter used to invoke a query interface of an information query system. In this way, a natural language processing capability of a large language model may be fully utilized, a multi-proxy service is not required, and a parameter that may be input to the query interface may be directly generated to invoke the query interface for an information query, so that a dependence of the information query process on the message queue and the proxy service is reduced, and an efficiency of the information query may be improved.

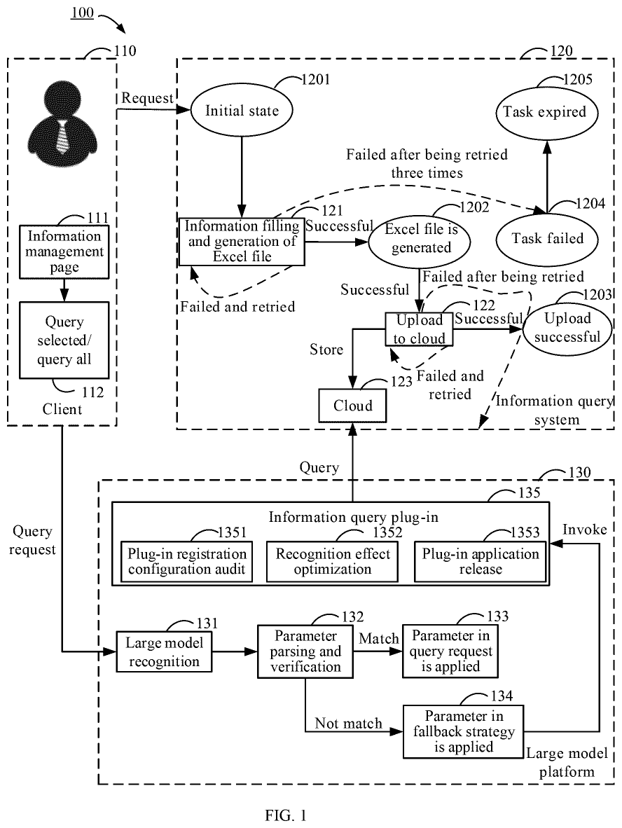

FIG. 1 schematically shows an exemplary system architecture to which a method and an apparatus of querying an information may be applied according to embodiments of the present disclosure.

It should be noted that FIG. 1 is just an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in other embodiments, the exemplary system architecture to which a method and an apparatus of querying an information may be applied may include a terminal device, but the terminal device may implement the method and apparatus of querying the information without interacting with a server.

As shown in FIG. 1, a system architecture 100 according to such embodiments may include a client 110, an information query system 120, and a large model platform 130.

Information files to be queried may be selected by a user, such as “query selected/query all” 112, on an information management page 111 of the client 110.

The information query system 120 may be used to process historical download information of the client 110 for the client to query.

For example, in an application scenario of bill information, there may be various types and forms of bills for different orders and different customers, and a diversity of bill types brings difficulties to an information query. Therefore, different types of bill contents may be processed in a unified manner and stored in a centralized manner to improve the efficiency of information query.

In embodiments of the present disclosure, upon receiving an information processing request from the client 110, the information query system 120 may establish a processing task, which has an initial state 1201. Then, it is possible to run the processing task to perform an information filling and generation of Excel file 121. For example, it is possible to generate an Excel file by an information filling of a content in a bill information in a form of image. In a case that an execution of the processing task is successful, an Excel file is generated 1202. In a case that the execution of the processing task fails, it is possible to retry the execution of the processing task. If the execution of the processing task still fails after being retried three times, the state of the processing task becomes task failed 1204. If the state of the processing task is still task failed 1204 after the processing task runs for more than a predetermined time limit, the state of the processing task becomes task expired 1205.

When the execution of the processing task is successful, it is possible to run a file transfer task to upload 122 the generated Excel file to a cloud, so that the Excel file is stored in the cloud 123. If an execution of the file transfer task is successful, a state of the file transfer task is upload successful 1203. If the execution of the file transfer task fails, it is possible to retry the execution of the file transfer task. If the execution of the file transfer task still fails after being retried, the state of the file transfer task becomes task failed 1204.

The large model platform 130 is used to acquire a query request from the client 110, input the query request into a large language model to perform a large model recognition 131, and output a target parameter. It is possible to match the target parameter with the query request through a parameter parsing and verification 132.

If the target parameter is matched with the query request, it means that a recognition result of the large language model is correct, and the output target parameter is consistent with the parameter in the query request. Then, a parameter from the query request may be applied 133 to invoke an information query plug-in 135 to query a target information from the information query system 120.

If the target parameter is not matched with the query request, it means that the recognition result of the large language model is incorrect, and the output target parameter is inconsistent with the parameter in the query request. Then, a parameter in a fallback strategy may be applied 134 to invoke the information query plug-in 135 to query the target information from the information query system 120.

In embodiments of the present disclosure, after a plug-in registration configuration audit 1351 of the information query plug-in 135, a plug-in application release 1353 may be achieved, so that the information query plug-in 135 may use the parameter output by the large language model as an input parameter of a query interface of the information query system, and directly invoke the query interface of the information query system to complete an information query operation.

In embodiments of the present disclosure, the plug-in registration configuration audit 1351 may be performed to register Open API (Open Application Programming Interface) configuration file of the information query plug-in 135 into a plug-in library of the large model platform, and the plug-in application release 1353 may be achieved after the audit of the large model platform.

In addition, the parameter output by the large language model may be inconsistent with the parameter of the query request. In order to optimize an output result of the large language model, a recognition effect optimization 1352 may be performed on the large language model. For example, based on a loss function, it is possible to calculate a loss value according to the output result of the large language model and an initially input request information, and fine-tune the parameter of the large language model based on the loss value until the loss value converges, so as to improve an accuracy of the information query result.

It should be noted that the method of querying the information provided in embodiments of the present disclosure may generally be performed by the large model platform 130. Accordingly, the apparatus of querying the information provided in embodiments of the present disclosure may also be provided in the large model platform 130.

It should be understood that the number of client, information query system and large model platform shown in FIG. 1 are just schematic. According to implementation needs, any number of client, information query system and large model platform may be provided.

In technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

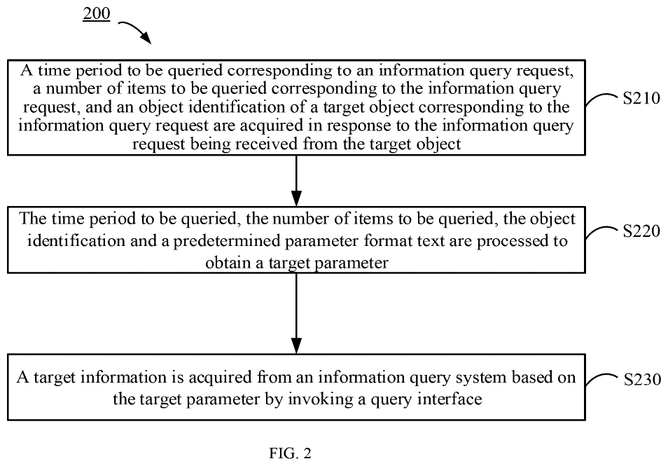

FIG. 2 schematically shows a flowchart of a method of querying an information according to embodiments of the present disclosure.

As shown in FIG. 2, a method 200 includes operation S210 to operation S230.

In operation S210, a time period to be queried corresponding to an information query request, a number of items to be queried corresponding to the information query request, and an object identification of a target object corresponding to the information query request are acquired in response to the information query request being received from the target object.

In operation S220, the time period to be queried, the number of items to be queried, the object identification and a predetermined parameter format text are processed to obtain a target parameter.

In operation S230, a target information is acquired from an information query system based on the target parameter by invoking a query interface.

According to embodiments of the present disclosure, the information query request may be generated based on a selection operation of the target object for the time period to be queried and the number of items to be queried on a target page. The target page may be configured according to query scenario requirements of specific items.

For example, the item to be queried may be an operation log, the time period to be queried may be selected as from January 2^{nd} to January 3^{rd}, and the number of items to be queried may be 5. Accordingly, the information query request may be a request to query five operation logs generated from January 2^{nd} to January 3^{rd}.

According to embodiments of the present disclosure, the information query request may also be in text form or may be obtained through a speech recognition. For example, the information query request may be “please query ten bill export records from 8 o'clock to 10 o'clock today”, then the time period to be queried may be “from 8 o'clock to 10 o'clock today”, and the number of items to be queried may be “10”.

According to embodiments of the present disclosure, the identification of the target object may represent an identity of the target object in the information query system, which may be used to verify whether the target object has a query permission, and may also be used to determine a range of queryable files.

For example, it is possible to configure a form for query permissions, in which a plurality of identifications with query permissions may be recorded. When it is determined that the identification of the target object is contained in the form, it may be determined that the target object has a query permission for the information query system.

For example, it is also possible to configure a mapping relationship between the identification and a query file identification to determine the queryable range of the target object in the information query system, so as to achieve a physical isolation of queryable data between different query objects to ensure data security.

According to embodiments of the present disclosure, the target parameter represents the input parameter of the query interface of the information query system. The predetermined parameter format text may represent a parameter format text that is matched with parameter format requirements of the query interface, so that the parameter format of the target parameter is matched with the query interface, and the target parameter may be directly input into the query interface.

For example, the predetermined parameter format text may include a time period to be queried-begin time field, a time period to be queried-end time field, an identification field, and a number of items field.

According to embodiments of the present disclosure, by using a natural language processing capability of the large language model, the time period to be queried, the number of items to be queried, the identification of the target object, and the predetermined parameter format text as a whole may be used as an input text and input into the large language model, so that the large language model outputs the target parameter used to invoke the query interface according to a context information of the input text and the predetermined parameter format text.

For example, the information query request of the target object T may be “please query ten bill export records from 8 o'clock to 10 o'clock today”, and the target parameter output by the large language model may be “ . . . beginTime: \20XX-01-03 08:00:00\ endTime: \ 20XX-01-03 10:00:00 \ FileCount\10\query “please query ten bill export records from 8 o'clock to 10 o'clock today”, T\ . . . ”.

According to embodiments of the present disclosure, the above-mentioned target parameter may be used as the input parameter of the query interface to invoke the query interface, so as to query the target information from the information query system.

According to embodiments of the present disclosure, the time period to be queried, the number of items to be queried and the identification of the target object are processed based on the predetermined parameter format text to obtain the target parameter used to invoke the query interface of the information query system, then the natural language processing capability of the large language model may be fully utilized, a multi-proxy service is not required, and a parameter that may be input to the query interface may be directly generated to invoke the query interface for an information query, so that a dependence of the information query process on the message queue and the proxy service is reduced, an impact of the information query process on the speed of other processing processes is reduced, and the efficiency of information query is improved.

As a basis of the information query, a unified format of information file needs to be constructed firstly. Accordingly, the above-mentioned method further includes: acquiring a content information of a target item and a predetermined template, where the predetermined template includes a filling position corresponding to a content, a name field, and a content field; and filling the content information into the content field corresponding to the name field according to the filling position, so as to generate an information of the target item.

According to embodiments of the present disclosure, the predetermined template corresponds to the target item and may be pre-configured according to the content of the target item. The target item may be any queryable item with diverse information forms, such as bill, document, and operation record, etc. The information of the target item may be an information file in a unified format.

According to embodiments of the present disclosure, the information of the target item is processed according to the predetermined template to generate the information file in the unified format, so that a redundant process of secondary processing of information in different formats during a process of information query is reduced, and the efficiency of information processing is further improved.

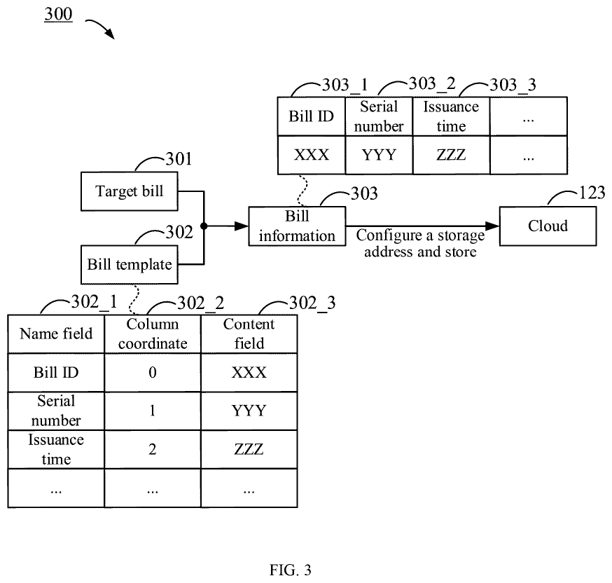

The method shown in FIG. 2 will be further described below in conjunction with specific embodiments with reference to FIG. 3.

FIG. 3 schematically shows a schematic diagram of an information processing and storage process according to embodiments of the present disclosure.

As shown in FIG. 3, in embodiment 300, taking an application scenario of bill information as an example, a process of processing and storing a bill information is illustrated.

In the application scenario of bill information, an issued electronic bill is generally downloaded by a user from a third-party application. The query is not easy due to the different types and forms of electronic bills. Therefore, it is possible to build a bill template to present bill contents of different forms of electronic bills in the same form, such as in an Excel file.

According to embodiments of the present disclosure, a bill template 302 may be created based on an open source library of Apache POI (Poor Obfuscation Implementation). The bill template 302 may include a name field 302_1, a column coordinate 302_2, and a content field 302_3. The name field may include a bill ID field, a serial number field, an issuance time field, etc. The content field corresponds to the name field. For example, if the bill ID in a target bill 301 is XXX, the content field corresponding to the name field “bill ID” may be “XXX”. The column coordinate may represent the filling position corresponding to the content, so that the name may correspond to the content.

For example, the content field “XXX” may be filled below the name field “bill ID” according to the column coordinate “0”, so as to generate a bill ID information 303_1. The content field “YYY” may be filled below the name field “serial number” according to the column coordinate “1”, so as to generate a serial number information 303_2. The content field “ZZZ” may be filled below the name field “issuance time” according to the column coordinate “2”, so as to generate a issuance time information 303_3. Then, a bill information 303 in a form of an Excel file may be obtained.

According to embodiments of the present disclosure, a storage address may be configured for the bill information, so that the bill information 303 may be stored in the cloud 123.

According to embodiments of the present disclosure, it is possible to configure a target storage address according to a download object identification of the target item, and store the information of the target item according to the target storage address.

According to embodiments of the present disclosure, the download object identification of the target item may correspond to the content information of the target item, and a mapping relationship between the download object identification and the target storage address may be configured in a configuration file, so as to achieve respective correspondence between the information of the target item and the storage address, facilitate the query, and further improve the query efficiency.

For example, the information of the target item may be converted into byte information and uploaded to the cloud 123 for storage.

According to embodiments of the present disclosure, different forms of content information may be processed based on the predetermined template, and the information format is unified. Furthermore, by configuring the storage address, the processed information files may be stored in the cloud, so that an occupancy of a storage space of the terminal device is reduced.

According to embodiments of the present disclosure, the above-mentioned operation S220 may include: constructing a prompt text according to the time period to be queried, the number of items to be queried, the identification of the target object, and the predetermined parameter format text; and processing the prompt text by using a generative large model to obtain the target parameter.

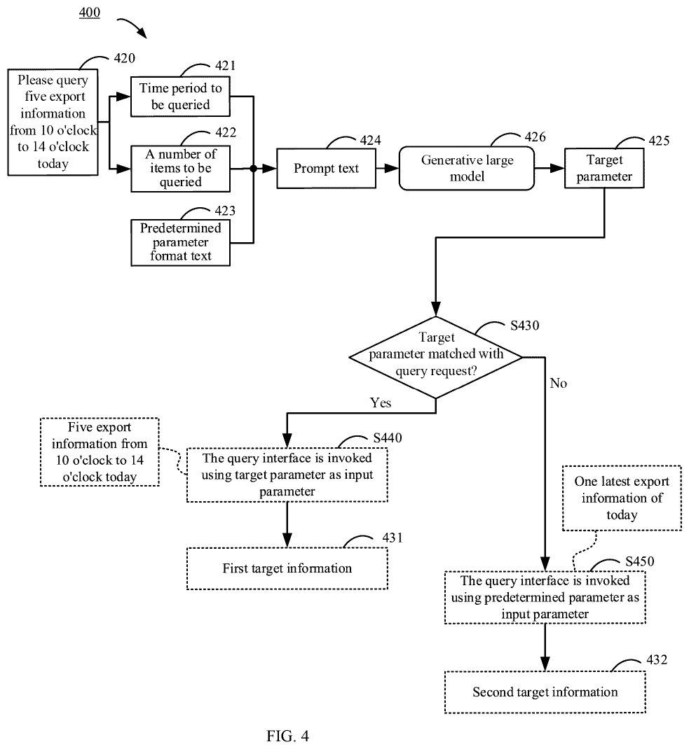

FIG. 4 schematically shows a schematic diagram of a method of querying an information according to embodiments of the present disclosure.

As shown in FIG. 4, in embodiment 400, an information query request 420 may be “please query five export information from 10 o'clock to 14 o'clock today”. A time period to be queried 421 acquired from the information query request 420 may be “from 10 o'clock to 14 o'clock today”, and a number of items to be queried 422 may be “5”. The predetermined parameter format text 423 may be determined according to an item type in the information query request.

According to embodiments of the present disclosure, the time period to be queried 421, the number of items to be queried 422 and the predetermined parameter format text 423 may be constructed as a prompt text 424. Then, the prompt text 424 may be input into a generative large model 426, and a target parameter 425 may be output based on the natural language processing ability of the generative large model 426 by using understanding of a context information in the prompt text 424 by the generative large model 426.

According to embodiments of the present disclosure, by constructing a prompt text containing the predetermined parameter format text, the generative large model may generate, according to the predetermined parameter format, a parameter that meets input format requirements of the information query interface, so that the query interface may be invoked directly using an output result of the generative large model, and the efficiency of information query may be further improved.

Although current generative large models have high processing accuracy, there may still be recognition errors, such as a format error of the target parameter, or an error of partial parameter content of the target parameter. Therefore, it is possible to provide an appropriate fallback strategy to ensure a normal execution of the query task.

According to embodiments of the present disclosure, the above-mentioned operation S230 may include: parsing the target parameter to obtain a parsing result, where the parsing result includes a target query period, a target number of items and an object identification; acquiring a query attribute information according to the parsing result; and acquiring a target information from the information query system according to the query attribute information; where the query attribute information includes the target query period, the target number of items and the object identification in response to the parsing result being matched with the information query request; and the query attribute information includes a predetermined query period, a predetermined number of query items, and the object identification in response to the parsing result being not matched with the information query request.

For example, the information query request 420 sent by the target object T may be “please query five export information from 10 o'clock to 14 o'clock today”. The target query period in the parsing result obtained by parsing the target parameter may be “from 10 o'clock to 14 o'clock today”, the target number of items may be “five export information”, and the identification of the target object may be “T”. Then, operation S430 is performed to match the target query period in the parsing result with the time period to be queried in the information query request, the target number of items in the parsing result with the number of items to be queried in the information query request, and the identification of the target object, so as to determine whether the target parameter is matched with the query request. After verification, it may be determined that the target parameter 425 is matched with the information query request 420. Then, operation S440 is performed to invoke the query interface using the target parameter “five export information from 10 o'clock to 14 o'clock today” as the input parameter, and a first target information 431 may be queried from the information query system.

For example, the information query request 420 sent by the target object T may be “please query five export information from 10 o'clock to 14 o'clock today”. The target query period in the parsing result obtained by parsing the target parameter may be “from 10 o'clock to 13 o'clock today”, the target number of items may be “four export information”, and the identification of the target object may be “T”. Then, operation S430 may be performed to match the target query period in the parsing result with the time period to be queried in the information query request, the target number of items in the parsing result with the number of items to be queried in the information query request, and the identification of the target object, so as to determine whether the target parameter is matched with the query request. After verification, it may be determined that the target parameter 425 is not matched with the information query request 420. Then, operation S450 is performed to invoke the query interface using a predetermined parameter “one latest export information of today” as the input parameter, and a second target information 432 may be queried from the information query system.

According to embodiments of the present disclosure, the fallback strategy may be determined according to the item type and the item content in the actual application scenario. For example, in the scenario of bill query, a probability of the latest downloaded/export information of the day being queried is high. Accordingly, if an incorrect target parameter is output by the large language model, the latest export information may be used as the fallback strategy for the information query.

According to embodiments of the present disclosure, by parsing and verifying the target parameter, it is possible to determine a matching degree between the output result of the large language model and the information query request, so as to improve the accuracy of the information query while simplifying a resource scheduling flow in the information query process. Moreover, by providing the appropriate predetermined parameter as a fallback strategy, it is possible to reduce an impact of error reporting in the information query system on the processing process, so that a stable operation of the system is further improved.

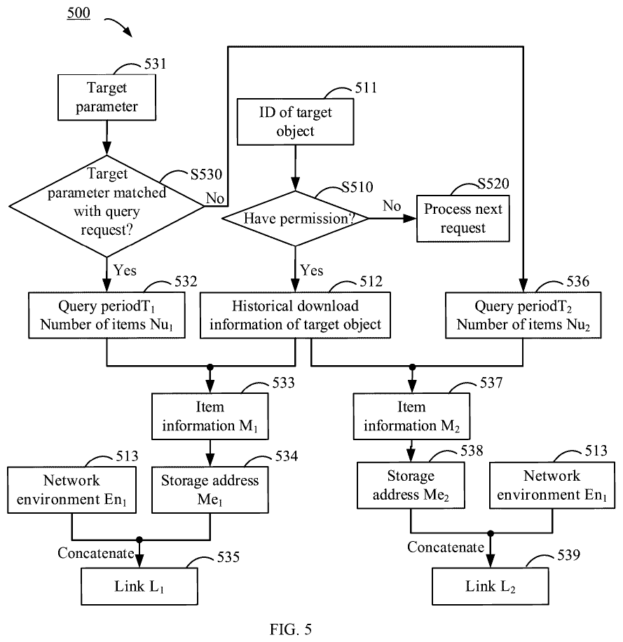

FIG. 5 schematically shows a schematic diagram of a method of querying an information according to other embodiments of the present disclosure.

As shown in FIG. 5, in embodiment 500, operation S510 may be performed firstly on the ID of the target object in the target parameter output by the large language model to verify whether the target object has a permission to access the information query system. If it is determined that the target object has an access permission, a historical download information 512 of the target object is determined from historical item download information of a plurality of target objects according to the identification of the target object. If it is determined that the target object has no access permission, operation S520 is performed to process a next request.

According to embodiments of the present disclosure, the information query system includes historical item download information of at least two target objects. Acquiring the target information from the information query system according to the query attribute information may include: determining a target historical item download information corresponding to the object identification from the historical item download information of the at least two target objects; and determining the target information corresponding to the query attribute information from the target historical item download information.

For the target parameter output by the large language model, operation S530 may be performed to determine whether a target parameter 531 is matched with the query request. If so, it is possible to determine the target information from the target historical item download information according to the target query period and the target number of items. For example, an item information M₁533 may be determined from a historical item download information 512 of the target object according to a query period T₁ and a number of items Nu₁532. The query period T₁ and the number of items Nu₁ represent the same time period to be queried and the same number of items to be queried as the information query request.

If not, a fallback strategy is executed to determine the target information from the target historical item download information according to a predetermine query period and a predetermined number of query items. For example, an item information M₂537 may be determined from the historical item download information 512 of the target object according to a query period T₂ and a number of items Nu₂536. The query period T₂ and the number of items Nu₂ represent a time period to be queried and a number of items to be queried that are completely different or at least partially different from those of the information query request.

For example, the information query request may be “please query five latest export records of today”, and the target parameter may be “? latest export records of today”. Then, it may be determined that the target parameter is not matched with the information query request. If the current parameter is directly input into the query interface of the information query system, due to the parameter error, the information query system may report an error and fail to continue the execution of the query task. In this case, it is possible to execute a fallback strategy, the predetermined query period may be a current time period of today, and the predetermined number of query items may be 1. By using the predetermined parameter in the fallback strategy as the input parameter of the query interface, the query result may at least partially meet the initial information query request, and the queried information is still valid for the target object.

According to embodiments of the present disclosure, the historical download record of the target object is firstly determined according to the identification of the target object, so that a physical isolation of stored data between different target objects may be achieved to improve data security. By providing the fallback strategy, it is still possible to query valid information when the target parameter is incorrect, so that a probability of error reporting in the information query system is reduced, and a stable operation of the system is further improved.

According to embodiments of the present disclosure, the information query system includes a mapping relationship between the information and the information storage address. Therefore, it is possible to determine the storage address information of the target information based on the mapping relationship; acquire a network environment information of the target object; and concatenate he storage address information and the network environment information to generate a target link information. The target link information is used for the target object to download the target information.

As shown in FIG. 5, it is possible to determine a storage address Me₁534 according to an item information M₁533 based on the mapping relationship, and concatenate a network environment En₁513 and the storage address Me₁534 to generate a link L₁535 which is used for the target object to download an item information M₁. It is also possible to determine a storage address Me₂538 according to an item information M₂537 based on the mapping relationship, and concatenate the network environment En₁513 and the storage address Me₂538 to generate a link L₂539 which is used for the target object to download an item information M₂.

According to embodiments of the present disclosure, there is a one-to-one correspondence between the network environment information of the target object and the identification of the target object, and the network environment information of the target object may be determined according to the identification of the target object by pre-configuring the mapping relationship between the network environment information and the identification.

According to embodiments of the present disclosure, since the target link information includes both the network environment of the target object and the storage address of the target information, it is possible to directly jump to an information download interface when the target link information is clicked by the user, so that the target information may be downloaded in a timely manner and the efficiency of information query may be improved.

According to embodiments of the present disclosure, for a method of returning the target information, in addition to providing a link information for downloading the target information, it is also possible to provide a rendering template and display the target information on the client in the form of a visual interface, so as to improve a user experience.

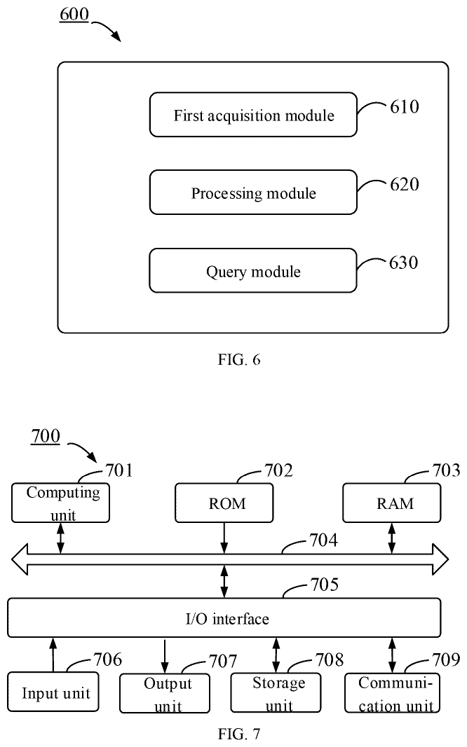

FIG. 6 schematically shows a block diagram of an apparatus of querying an information according to embodiments of the present disclosure.

As shown in FIG. 6, an apparatus 600 of querying an information may include a first acquisition module 610, a processing module 620, and a query module 630.

The first acquisition module 610 is used to acquire a time period to be queried corresponding to an information query request, a number of items to be queried corresponding to the information query request and an object identification of a target object corresponding to the information query request, in response to receiving the information query request from the target object.

The processing module 620 is used to process the time period to be queried, the number of items to be queried, the object identification and a predetermined parameter format text to obtain a target parameter, where the target parameter represents an input parameter of a query interface of an information query system.

The query module 630 is used to acquire, by invoking the query interface, a target information from the information query system based on the target parameter.

According to embodiments of the present disclosure, the query module includes a parsing sub-module, an acquisition sub-module, and a query sub-module.

The parsing sub-module is used to parse the target parameter to obtain a parsing result, where the parsing result includes a target query period, a target number of items and the object identification.

The acquisition sub-module is used to acquire a query attribute information according to the parsing result.

The query sub-module is used to acquire the target information from the information query system according to the query attribute information. In response to the parsing result being matched with the information query request, the query attribute information includes the target query period, the target number of items and the object identification. In response to the parsing result being not matched with the information query request, the query attribute information includes a predetermined query period, a predetermined number of query items and the object identification.

According to embodiments of the present disclosure, the information query system includes historical item download information of at least two target objects; and the query sub-module may include a first determination unit and a second determination unit.

The first determination unit is used to determine a target historical item download information corresponding to the object identification from the historical item download information of the at least two target objects.

The second determination unit is used to determine, from the target historical item download information, the target information corresponding to the query attribute information.

According to embodiments of the present disclosure, the information query system includes a mapping relationship between an information and an information storage address; and the apparatus further includes a determination module, a second acquisition module and a first generation module.

The determination module is used to determine a storage address information of the target information based on the mapping relationship.

The second acquisition module is used to acquire a network environment information of the target object.

The first generation module is used to concatenate the storage address information and the network environment information to generate a target link information, where the target link information is generated for the target object to download the target information.

According to embodiments of the present disclosure, the processing module may include a construction sub-module and a processing sub-module.

The construction sub-module is used to construct a prompt text according to the time period to be queried, the number of items to be queried, the object identification and the predetermined parameter format text. The processing sub-module is used to process the prompt text by using a generative large model to obtain the target parameter.

According to embodiments of the present disclosure, the apparatus may further include a third acquisition module and a third generation module.

The third acquisition module is used to acquire a content information of a target item and a predetermined template, where the predetermined template includes a filling position corresponding to a content, a name field, and a content field.

The third generation module is used to fill the content information into the content field corresponding to the name field according to the filling position, so as to generate an information of the target item.

According to embodiments of the present disclosure, the apparatus may further include a configuration module and a storage module. The configuration module is used to configure a target storage address according to a download object identification of the target item. The storage module is used to store the information of the target item according to the target storage address.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, cause the at least one processor to implement the method described above.

According to embodiments of the present disclosure, a non-transitory computer-readable storage medium having computer instructions therein is provided, and the computer instructions are used to cause a computer to implement the method described above.

According to embodiments of the present disclosure, a computer program product containing a computer program is provided, and the computer program, when executed by a processor, causes the processor to implement the method described above.

FIG. 7 shows a schematic block diagram of an example electronic device 700 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the electronic device 700 may also be stored. The computing unit 701, the ROM 702 and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver. The communication unit 709 allows the electronic device 700 to exchange information/data with other devices through a computer network such as Internet and/or various telecommunication networks.

The computing unit 701 may be various general-purpose and/or dedicated processing assemblies having processing and computing capabilities. Some examples of the computing units 701 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 701 executes various methods and processes described above, such as the method of querying the information. For example, in some embodiments, the method of querying the information may be implemented as a computer software program which is tangibly embodied in a machine-readable medium, such as the storage unit 708. In some embodiments, the computer program may be partially or entirely loaded and/or installed in the electronic device 700 via the ROM 702 and/or the communication unit 709. The computer program, when loaded in the RAM 703 and executed by the computing unit 701, may execute one or more steps in the method of querying the information described above. Alternatively, in other embodiments, the computing unit 701 may be used to perform the method of querying the information by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of querying an information, comprising:
acquiring a time period to be queried corresponding to an information query request, a number of items to be queried corresponding to the information query request and an object identification of a target object corresponding to the information query request, in response to receiving the information query request from the target object;
processing the time period to be queried, the number of items to be queried, the object identification and a predetermined parameter format text to obtain a target parameter, wherein the target parameter represents an input parameter of a query interface of an information query system; and
acquiring, by invoking the query interface, a target information from the information query system based on the target parameter.

2. The method according to claim 1, wherein the acquiring, by invoking the query interface, a target information from the information query system based on the target parameter comprises:
parsing the target parameter to obtain a parsing result, wherein the parsing result comprises a target query period, a target number of items and the object identification;
acquiring a query attribute information according to the parsing result; and
acquiring the target information from the information query system according to the query attribute information;
wherein the query attribute information comprises the target query period, the target number of items and the object identification, in response to the parsing result being matched with the information query request; and
wherein the query attribute information comprises a predetermined query period, a predetermined number of query items and the object identification, in response to the parsing result being not matched with the information query request.

3. The method according to claim 2, wherein the information query system comprises historical item download information of at least two target objects; and
wherein the acquiring the target information from the information query system according to the query attribute information comprises:
determining a target historical item download information corresponding to the object identification from the historical item download information of the at least two target objects; and
determining, from the target historical item download information, the target information corresponding to the query attribute information.

4. The method according to claim 1, wherein the information query system comprises a mapping relationship between an information and an information storage address; and
wherein the method further comprises:
determining a storage address information of the target information based on the mapping relationship;
acquiring a network environment information of the target object; and
concatenating the storage address information and the network environment information to generate a target link information, wherein the target link information is generated for the target object to download the target information.

5. The method according to claim 1, wherein the processing the time period to be queried, the number of items to be queried, the object identification and a predetermined parameter format text to obtain a target parameter comprises:
constructing a prompt text according to the time period to be queried, the number of items to be queried, the object identification and the predetermined parameter format text; and
processing the prompt text by using a generative large model to obtain the target parameter.

6. The method according to claim 1, further comprising:
acquiring a content information of a target item and a predetermined template, wherein the predetermined template comprises a filling position corresponding to a content, a name field, and a content field; and
filling the content information into the content field corresponding to the name field according to the filling position, so as to generate an information of the target item.

7. The method according to claim 6, further comprising:
configuring a target storage address according to a download object identification of the target item; and
storing the information of the target item according to the target storage address.

8. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
acquire a time period to be queried corresponding to an information query request, a number of items to be queried corresponding to the information query request and an object identification of a target object corresponding to the information query request, in response to receiving the information query request from the target object;
process the time period to be queried, the number of items to be queried, the object identification and a predetermined parameter format text to obtain a target parameter, wherein the target parameter represents an input parameter of a query interface of an information query system; and
acquire, by invoking the query interface, a target information from the information query system based on the target parameter.

9. The electronic device according to claim 8, wherein the at least one processor is further configured to:
parse the target parameter to obtain a parsing result, wherein the parsing result comprises a target query period, a target number of items and the object identification;
acquire a query attribute information according to the parsing result; and
acquire the target information from the information query system according to the query attribute information;
wherein the query attribute information comprises the target query period, the target number of items and the object identification, in response to the parsing result being matched with the information query request; and
wherein the query attribute information comprises a predetermined query period, a predetermined number of query items and the object identification, in response to the parsing result being not matched with the information query request.

10. The electronic device according to claim 9, wherein the information query system comprises historical item download information of at least two target objects; and
wherein the at least one processor is further configured to:
determine a target historical item download information corresponding to the object identification from the historical item download information of the at least two target objects; and
determine, from the target historical item download information, the target information corresponding to the query attribute information.

11. The electronic device according to claim 8, wherein the information query system comprises a mapping relationship between an information and an information storage address; and
wherein the at least one processor is further configured to:
determine a storage address information of the target information based on the mapping relationship;
acquire a network environment information of the target object; and
concatenate the storage address information and the network environment information to generate a target link information, wherein the target link information is generated for the target object to download the target information.

12. The electronic device according to claim 8, wherein the at least one processor is further configured to:
construct a prompt text according to the time period to be queried, the number of items to be queried, the object identification and the predetermined parameter format text; and
process the prompt text by using a generative large model to obtain the target parameter.

13. The electronic device according to claim 8, wherein the at least one processor is further configured to:
acquire a content information of a target item and a predetermined template, wherein the predetermined template comprises a filling position corresponding to a content, a name field, and a content field; and
fill the content information into the content field corresponding to the name field according to the filling position, so as to generate an information of the target item.

14. The electronic device according to claim 13, wherein the at least one processor is further configured to:
configure a target storage address according to a download object identification of the target item; and
store the information of the target item according to the target storage address.

15. A non-transitory computer-readable storage medium having computer instructions therein, wherein the computer instructions are configured to cause a computer to:
acquire a time period to be queried corresponding to an information query request, a number of items to be queried corresponding to the information query request and an object identification of a target object corresponding to the information query request, in response to receiving the information query request from the target object;
process the time period to be queried, the number of items to be queried, the object identification and a predetermined parameter format text to obtain a target parameter, wherein the target parameter represents an input parameter of a query interface of an information query system; and
acquire, by invoking the query interface, a target information from the information query system based on the target parameter.

16. The non-transitory computer-readable storage medium according to claim 15, wherein the computer instructions are further configured to cause the computer to:
parse the target parameter to obtain a parsing result, wherein the parsing result comprises a target query period, a target number of items and the object identification;
acquire a query attribute information according to the parsing result; and
acquire the target information from the information query system according to the query attribute information;
wherein the query attribute information comprises the target query period, the target number of items and the object identification, in response to the parsing result being matched with the information query request; and
wherein the query attribute information comprises a predetermined query period, a predetermined number of query items and the object identification, in response to the parsing result being not matched with the information query request.

17. The non-transitory computer-readable storage medium according to claim 16, wherein the information query system comprises historical item download information of at least two target objects; and
wherein the computer instructions are further configured to cause the computer to:
determine a target historical item download information corresponding to the object identification from the historical item download information of the at least two target objects; and
determine, from the target historical item download information, the target information corresponding to the query attribute information.

18. The non-transitory computer-readable storage medium according to claim 15, wherein the information query system comprises a mapping relationship between an information and an information storage address; and
wherein the computer instructions are further configured to cause the computer to:
determine a storage address information of the target information based on the mapping relationship;
acquire a network environment information of the target object; and
concatenate the storage address information and the network environment information to generate a target link information, wherein the target link information is generated for the target object to download the target information.

19. The non-transitory computer-readable storage medium according to claim 15, wherein the computer instructions are further configured to cause the computer to:
construct a prompt text according to the time period to be queried, the number of items to be queried, the object identification and the predetermined parameter format text; and
process the prompt text by using a generative large model to obtain the target parameter.

20. The non-transitory computer-readable storage medium according to claim 15, wherein the computer instructions are further configured to cause the computer to:
acquire a content information of a target item and a predetermined template, wherein the predetermined template comprises a filling position corresponding to a content, a name field, and a content field; and
fill the content information into the content field corresponding to the name field according to the filling position, so as to generate an information of the target item.
